(19) United States
(12) Patent Application Publication
(10) Pub. No.: US 2025/0076674 A1
(43) Pub. Date: Mar. 6, 2025

(54) VIRTUAL IMAGE DISPLAY DEVICE AND OPTICAL UNIT

(71) Applicant: SEIKO EPSON CORPORATION, Tokyo (JP)

(72) Inventors: Takashi TAJIRI, MATSUMOTO-SHI (JP); Jun IROBE, SUWA-SHI (JP)

(73) Assignee: SEIKO EPSON CORPORATION, Tokyo (JP)

(21) Appl. No.: 18/818,633

(22) Filed: Aug. 29, 2024

(30) Foreign Application Priority Data
Aug. 31, 2023 (JP) 2023-140879

(51) Int. Cl. G02B 27/44; G02B 27/01; G02B 27/18

(52) U.S. Cl. CPC G02B 27/44; G02B 27/0172; G02B 27/18; G02B 2027/0114; G02B 2027/0118; G02B 2027/0178

(57) ABSTRACT

A virtual image display device includes a display panel configured to emit image light, a projection optical system configured to collimate the image light from the display panel, and a light guide member that includes a light guide plate configured to guide the image light, an input diffractive optical element configured to cause the image light to enter the light guide plate, and an output diffractive optical element configured to cause the image light to be emitted from the light guide plate, wherein the input diffractive optical element is divided into a plurality of regions, and the plurality of regions are different from each other in an inclined angle of a grating in accordance with an angle of incidence of the image light.

The present application is based on, and claims priority from JP Application Serial Number 2023-140879, filed Aug. 31, 2023, the disclosure of which is hereby incorporated by reference herein in its entirety.

### BACKGROUND

### 1. Technical Field

The present disclosure relates to a virtual image display device and an optical unit that enable observation of a virtual image.

### 2. Related Art

An image display apparatus that enables observation of a virtual image includes one in which two light guide plates are provided and diffraction optical elements are provided on a light incident surface and a light emission surface of each light guide plate (JP-A-2015-49376). In the apparatus disclosed in JP-A-2015-49376, a surface relief type diffraction grating is used as a diffraction optical element. The surface relief type diffraction grating has dependency on a wavelength and an angle of incidence, and diffraction efficiency changes depending on the wavelength and the angle of incidence. Therefore, color non-uniformity and luminance non-uniformity of an image are likely to occur. In the apparatus disclosed in JP-A-2015-49376, the diffraction efficiency is enhanced by inclining a grating surface of the diffraction optical element on the light incident surface. In the two light guide plates, the diffraction optical element on the light incident surface is optimized for beams of incident light of different wavelengths by using gratings having different diffraction efficiencies, thereby reducing color non-uniformity. Further, by changing the diffraction efficiency of the diffraction optical element on the light emission side for each region, the amount of emitted light in the eyebox is uniformized.

In the apparatus disclosed in JP-A-2015-49376, since image light of all angles of view enters the light incident surface, the diffraction efficiency changes for each angle of view. For this reason, in the apparatus disclosed in JP-A-2015-49376, a countermeasure for improving luminance non-uniformity in which brightness and darkness are produced depending on an angle of view when an image is viewed is insufficient.

### SUMMARY

A virtual image display device or an optical unit according to an aspect of the present disclosure includes a display panel configured to emit image light, a projection optical system configured to collimate the image light from the display panel, and a light guide member that includes a light guide plate configured to guide the image light, an input diffractive optical element configured to cause the image light to enter the light guide plate, and an output diffractive optical element configured to cause the image light to be emitted from the light guide plate, wherein the input diffractive optical element is divided into a plurality of regions, and the plurality of regions are different from each other in an inclined angle of a grating in accordance with an angle of incidence of the image light.

### BRIEF DESCRIPTION OF THE DRAWINGS

FIG. 1 is a plan view used to explain a mounted state of an HMD as a first embodiment.

FIG. 2 is a side view used to explain an arrangement and the like of an optical system included in a virtual image display device.

FIG. 3 is a plan view used to explain the arrangement and the like of the optical system included in the virtual image display device.

FIG. 4 is a back view used to explain a light guide optical system or a light guide member.

FIG. 5 is a conceptual diagram used to explain an optical system of a first display driving unit.

FIG. 6 is a partially enlarged view of an input diffractive optical element.

FIG. 7 is a conceptual diagram used to explain a relationship between a wave number vector and a grating vector.

FIG. 8 is a conceptual diagram used to explain a vector of a slanted type diffraction grating.

FIG. 9 is a conceptual diagram used to explain a vector of a diffraction grating of an input diffractive optical element according to the first embodiment.

FIG. 10 is a conceptual diagram used to explain an optical system according to a second embodiment.

FIG. 11 is a conceptual diagram used to explain an optical system according to a third embodiment.

FIG. 12 is a conceptual diagram used to explain a modification of the optical system according to the third embodiment.

FIG. 13 is a conceptual diagram used to explain an optical system according to a fourth embodiment.

FIG. 14 is a conceptual diagram used to explain an optical system according to a fifth embodiment.

FIG. 15 is a partially enlarged back view used to explain a modification of the input diffractive optical element.

### DESCRIPTION OF EMBODIMENTS

### First Embodiment

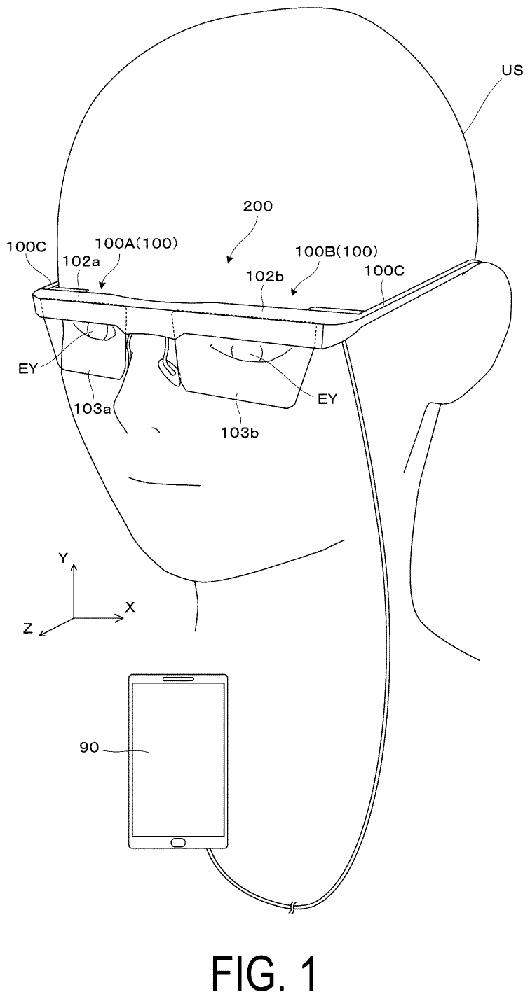

Below, a first embodiment of a virtual image display device according to the present disclosure will be described with reference to FIGS. 1 to 3 and the like.

FIG. 1 is a diagram used to explain a mounted state of a head-mounted display apparatus (hereinafter, also referred to as a head-mounted display or an “HMD”) 200, and the HMD 200 allows an observer or wearer US who is wearing the HMD 200 to recognize an image as a virtual image. In FIG. 1 and the like, X, Y, and Z represent a rectangular coordinate system. The +X direction corresponds to a lateral direction in which both eyes EY of the observer or the wearer US who wears the HMD 200 are arranged. The +Y direction corresponds to the upper direction perpendicular to the lateral direction from the viewpoint of the wearer US in which both eyes EY are arranged. The +Z direction corresponds to the forward direction or the front side direction from the viewpoint of the wearer US. The +Y direction is parallel to the vertical axis or the vertical direction.

The HMD 200 includes a first virtual image display device 100A for the right eye, a second virtual image display device 100B for the left eye, a pair of temple-type support devices 100C that support the virtual image display devices 100A and 100B, and a user terminal 90 being an information terminal. The first virtual image display device 100A alone functions as the HMD, and includes a first display driving unit 102a disposed at an upper portion, and a first light guide optical system 103a having a shape of a spectacle lens and covering the front of the eye. Similarly, the second virtual image display device 100B alone functions as the HMD, and includes a second display driving unit 102b disposed at the upper portion, and a second light guide optical system 103b having a shape of a spectacle lens and covering the front of the eye. The support devices 100C are mounting members mounted on a head of the wearer US, and support upper end sides of the pair of light guide optical systems 103a and 103b via the display driving units 102a and 102b that are integrated in appearance. The first virtual image display device 100A and the second virtual image display device 100B are optically left-right inverted, and detailed description of the second virtual image display device 100B will be omitted.

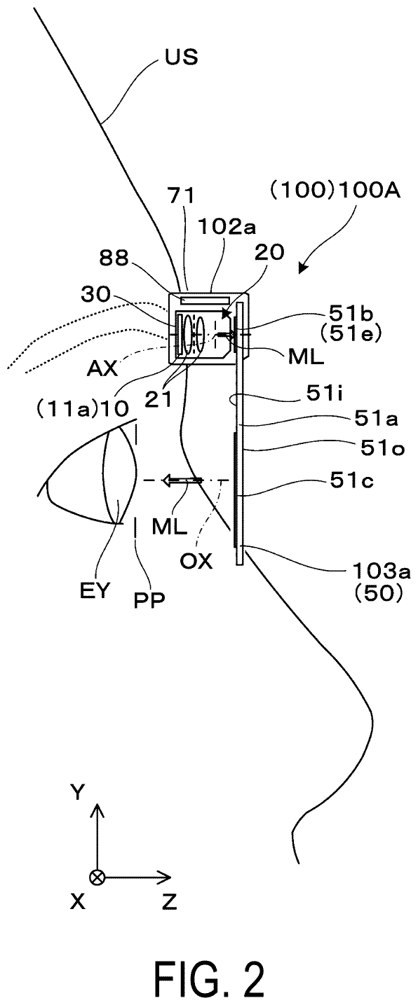

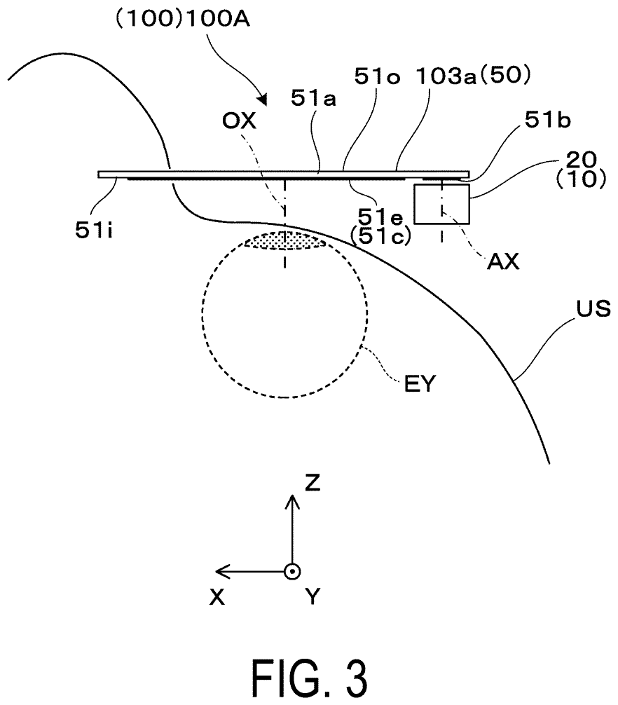

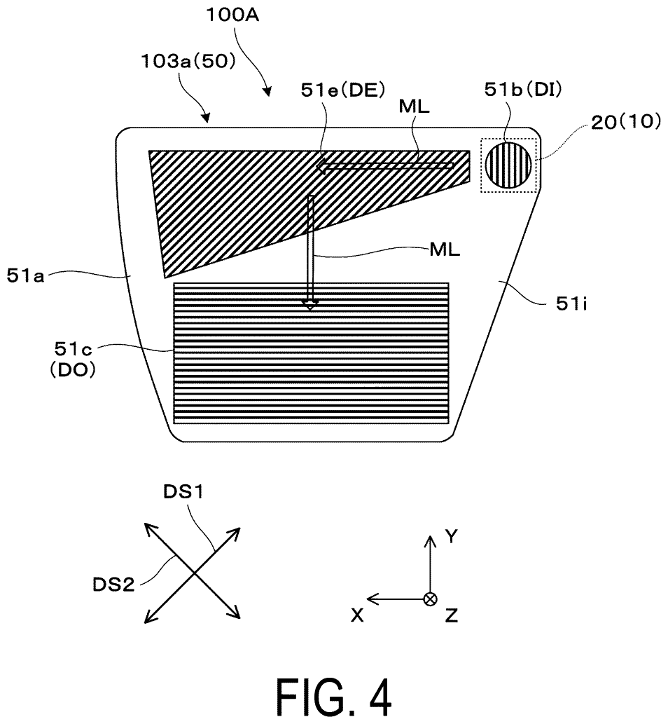

FIG. 2 is a side view used to specifically explain the first display driving unit 102a and the first light guide optical system 103a of the first virtual image display device 100A. FIG. 3 is a plan view used to specifically explain the first display driving unit 102a and the first light guide optical system 103a. FIG. 4 is a back view mainly used to explain the first light guide optical system 103a.

Referring to FIGS. 2 and 3, the first display driving unit 102a includes an image light generation device 10, a projecting optical system 20, and a drive circuit member 88. The image light generation device 10 is an optical engine including a display panel 11a. The projecting optical system 20 is a collimator including a plurality of lens elements 21. Image light ML generated by the image light generation device 10 is collimated by the projecting optical system 20, and is coupled to the first light guide optical system 103a serving as a light guide member 50. With the collimation, the diffused light is optically adjusted by an optical element so as to be in a parallel state to form collimated light, that is, parallel light. The drive circuit member 88 causes the display panel 11a to perform a display operation. Note that, in the first virtual image display device 100A, an optical device excluding the drive circuit member 88 is referred to as an optical unit 100. The first virtual image display device 100A guides the image light ML to the eyes EY of the wearer US, to make the wearer US visually recognize a virtual image.

Referring to FIG. 4, the first light guide optical system 103a is the light guide member 50 that enables color display, and extends substantially parallel to the XY plane. The first light guide optical system 103a includes a light guide plate 51a, an incident diffractive layer 51b, a pupil expanding grating layer 51e, and an emission diffractive layer 51c. The incident diffractive layer 51b, the emission diffractive layer 51c, and the pupil expanding grating layer 51e perform diffraction based on the wavelength of the image light ML. The incident diffractive layer 51b guides the collimated image light ML from the first display driving unit 102a (see FIG. 2) into the light guide plate 51a and makes the image light ML propagate in the lateral direction. The pupil expanding grating layer 51e makes the image light ML, propagating in the lateral direction in the light guide plate 51a, propagate in the lower direction while having the pupil size expanded. The emission diffractive layer 51c makes the image light ML, propagating in the lower direction in the light guide plate 51a, emitted toward a pupil position PP (see FIG. 2) set on the inner side where the eyes EY exist (see FIG. 2), while having the pupil size expanded.

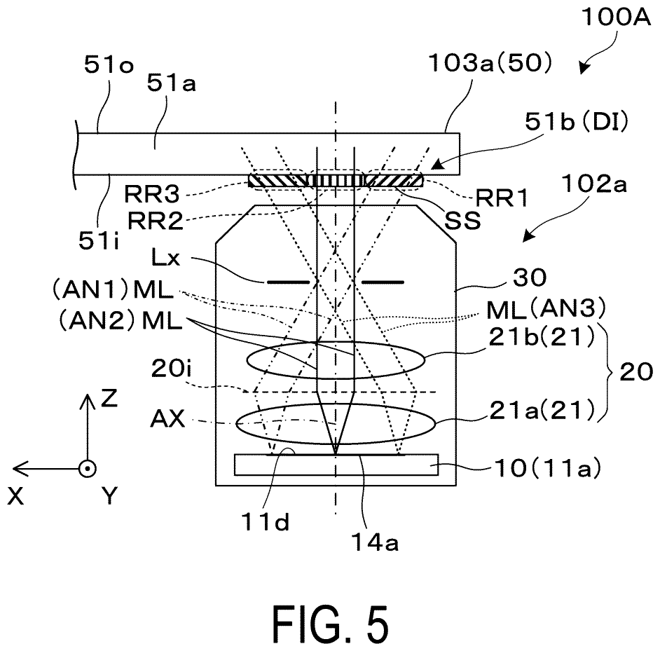

FIG. 5 is a diagram used to explain an optical system of the first display driving unit 102a. In the first display driving unit 102a, the image light generation device 10 includes only one display panel 11a. That is, the display panel 11a includes pixels of three colors RGB, and the pixels of the respective colors are two-dimensionally arranged in the display panel 11a. The projecting optical system 20 includes the plurality of lens elements 21. The display panel 11a and the projecting optical system 20 are fixed in a state of being positioned with respect to each other by a lens barrel 30. The lens barrel 30 is supported together with the drive circuit member 88 by a holder 71 (see FIG. 2) also serving as a cover while being positioned with respect to each other, and is fixed to the first light guide optical system 103a.

The display panel 11a is a display element or a display device that emits the image light ML to form an image corresponding to a virtual image. Specifically, the image display panel 11a is, for example, a display of various light emitting element arrays such as an organic light emitting diode (OLED), a micro OLED, an organic electro-luminescence (EL), inorganic EL, LED, or micro LED and forms a still image or movie on a two-dimensional display surface parallel to the XY plane. The display panel 11a includes a light emitting element 14a. The light emitting element 14a includes a large number of pixel elements two-dimensionally arranged on a substrate along the XY plane. When the display panel 11a is an OLED display, the pixel elements of the light emitting element 14a each include a cathode, an electron transport layer, a light emitting layer, a hole transport layer, and a transparent electrode layer, arranged in this order from the substrate.

The display panel 11a is not limited to a self-luminous image light generation device and may be made of an LCD or other light modulation element and form an image by illuminating the light modulation element with a light source such as a back ground. As the display panel 11a, a liquid crystal on silicon (trade name, LCOS is a registered trade name), a digital micromirror device (specifically, DLP (registered trade name)), a laser beam scan, or the like can be used instead of an LCD.

The projecting optical system 20 includes a first lens 21a and a second lens 21b, as the lens elements 21 with which the incident light is collimated. The projecting optical system 20 has a function substantially equivalent to that of a single lens 20i, collimates the image light ML emitted from a display surface 11d of the display panel 11a to be in a state of having a predetermined beam width, and emits the resultant image light ML toward the incident diffractive layer 51b. As will be described in detail later, the incident diffractive layer 51b has a grating with an inclined angle corresponding to the angle of incidence of the image light ML. Here, the angle of incidence of the image light ML is an angle of the image light ML corresponding to each angle of view of the image. In other words, the angle of incidence of the image light ML is an angle of incidence of standard incident light from a certain image point, and is an angle of incidence of the image light ML in which the principal light beam passes through the center of a predetermined region (to be specific, the regions RR1 to RR3 of the incident diffractive layer 51b).

The projecting optical system 20 may include an optical element such as a reflection mirror, in addition to one or more lens elements made of resin or glass. The optical surface of the optical element of the projecting optical system 20 may be any one of a spherical surface, an aspherical surface, and a free form surface.

An emission pupil Lx of the projecting optical system 20 is arranged at a position shifted from a grating surface SS corresponding to the surface of the incident diffractive layer 51b. Accordingly, the input position of the image light ML to the incident diffractive layer 51b changes according to the angle of incidence of the image light ML. In the present embodiment, the emission pupil Lx is disposed between the lens element 21 of the projecting optical system 20 and the incident diffractive layer 51b.

The light guide plate 51a is a member formed of a parallel flat plate, and has a first total reflection surface 51i and a second total reflection surface 510 that form a pair of flat surfaces extending along the XY plane.

Referring back to FIG. 4, in the first light guide optical system 103a or the light guide member 50, the incident diffractive layer 51b, the emission diffractive layer 51c, and the pupil expanding grating layer 51e are formed on the first total reflection surface 51i of the light guide plate 51a.

The incident diffractive layer 51b is an input diffractive optical element DI, and makes the image light ML, which has been emitted from the display panel 11a of the image light generation device 10 and entered through the lens element 21 of the projecting optical system 20, folded back and thus propagate inside the light guide member 50. The image light ML collimated around the optical axis AX (see FIG. 2) perpendicular to the light guide plate 51a enters the incident diffractive layer 51b. The incident diffractive layer 51b is formed with a diffraction pattern that extends linearly in the vertical Y direction and repeats periodically in the horizontal X direction.

The pupil expanding grating layer 51e is a pupil expanding diffractive optical element DE, is provided on the +X side of the incident diffractive layer 51b, and bends the optical path to make the image light ML, which is guided in the light guide plate 51a and advancing as a whole in the +X direction, advance as a whole in the −Y direction. The pupil expanding grating layer 51e changes the diffracting direction without substantially impairing angle information of the image light ML regarding the left and right X direction and angle information of the image light ML regarding the upper and lower Y direction. The pupil expanding grating layer 51e expands the pupil in the emission diffractive layer 51c, while guiding the image light ML, guided in the light guide plate 51a from the incident diffractive layer 51b, into the emission diffractive layer 51c. More specifically, the pupil expanding grating layer 51e is interposed between the incident diffractive layer 51b and the emission diffractive layer 51c, guides the image light ML in a direction (−Y direction) intersecting with the diffracting direction (+X direction) of the incident diffractive layer 51b while dividing the light beam, and has a function of expanding the beam width in the lateral direction. The pupil expanding grating layer 51e is formed with a diffraction pattern that extends linearly in an oblique direction DS1 parallel to the XY plane and repeats periodically in a direction DS2 parallel to the XY plane and perpendicular to the direction DS1. The direction DS1 is a direction rotated clockwise by 45 degrees with respect to the +Y direction, and is an intermediate direction between the −X direction and the +Y direction. The grating period or the pitch in the X direction and the Y direction of the pattern formed on the pupil expanding grating layer 51e matches the grating period in the X direction of the pattern formed on the incident diffractive layer 51b and the grating period in the Y direction of the pattern formed on the emission diffractive layer 51c.

The emission diffractive layer 51c, which is an output diffractive optical element DO, divides the light beam while guiding the image light ML in the −Y direction, and has a function of expanding the light beam width in the vertical direction. As a result, the beam width, in the X direction and the Y direction, of the image light ML to enter the pupil position PP illustrated in FIG. 2 has a range corresponding to the emission diffractive layer 51c, and the pupil size in the vertical direction and the lateral direction increases through the pupil expanding grating layer 51e, the emission diffractive layer 51c, and the like. The image light ML collimated around the emission optical axis OX (see FIG. 2) perpendicular to the light guide plate 51a is emitted from the emission diffractive layer 51c. The image light ML emitted from the emission diffractive layer 51c has an angle of about +25° with respect to the emission optical axis OX. Thus, the angle of view of the first virtual image display device 100A is about 50°. The emission diffractive layer 51c is formed by a diffraction pattern extending linearly in the lateral X direction, and periodically repeating in the vertical Y direction.

The incident diffractive layer 51b, the emission diffractive layer 51c, and the pupil expanding grating layer 51e are formed of a surface relief type diffraction element or diffraction grating, for example. The surface relief type diffraction grating is formed by nanoimprinting, but is not limited thereto, and may be formed by etching a surface of the light guide plate 51a, or may be formed by bonding a diffraction element or a diffraction grating. The material of the diffraction grating is a nano-imprint material when nano-imprinting is employed for the fabrication, and is the same material as the light guide plate 51a when etching is employed for the fabrication. The material of the light guide plate 51a is, for example, glass, resin, or the like.

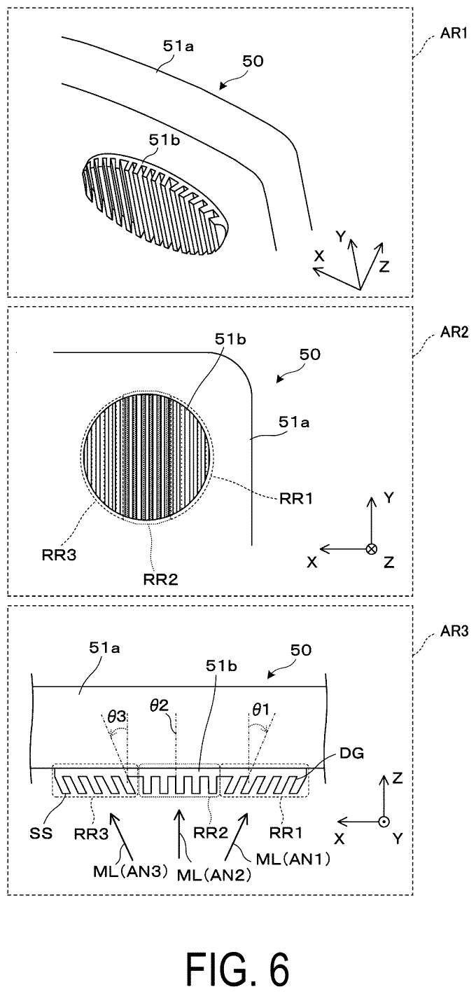

FIG. 6 is a partial enlarged view used to explain the incident diffractive layer 51b. In FIG. 6, a region AR1 is a partially enlarged perspective view of the incident diffractive layer 51b. A region AR2 is a partially enlarged back view of the incident diffractive layer 51b. A region AR3 is a partially enlarged side view of the incident diffractive layer 51b. Here, in a lateral cross section of the incident diffractive layer 51b passing through the orthogonal axis perpendicular to the surface of the light guide plate 51a, rotation in a first direction with respect to the orthogonal axis is defined as a positive angle, and rotation in a second direction opposite to the first direction with respect to the orthogonal axis is defined as a negative angle. More specifically, in the region AR3, inclined angles θ1 to θ3 of a grating DG are set to 0° with reference to the z-axis corresponding to the orthogonal axis, rotation in the +x direction corresponds to the +direction, and rotation in the −x direction corresponds to the −direction (the same applies to the subsequent drawings). The same definition of positive and negative of the angle applies to angles of incidence AN1 to AN3 of the image light ML. The inclined angles θ1 to θ3 of the grating DG of the incident diffractive layer 51b are expressed in a range of −90° or more and +90° or less. The inclined angle with respect to the angle of incidence of 0° may be 0° or may not be 0°.

The incident diffractive layer 51b has a slanted type grating structure. The incident diffractive layer 51b is divided into a plurality of regions RR1 to RR3, and the inclined angles θ1 to θ3 of the grating DG in the plurality of regions RR1 to RR3 are different from each other according to the angles of incidence AN1 to AN3 of the image light ML. The inclined angles θ1 to θ3 change in accordance with the position of the emission pupil Lx with respect to the incident diffractive layer 51b. In the example in FIG. 5, when the emission pupil Lx is arranged on the inner side of the incident diffractive layer 51b, the inclined angles θ1 and θ3 of the gratings DG of the outer side regions RR1 and RR3 are inclined inward with respect to the center of the incident diffractive layer 51b, in the incident diffractive layer 51b viewed from the projecting optical system 20. That is, the inclined angles θ1 and θ3 of the gratings DG in the outer side regions RR1 and RR3 are different from each other in that one is positive and the other is negative. The inclined angles θ1 to θ3 of the grating DG increase from the incident diffractive layer 51b side toward the emission diffractive layer 51c side in the lateral direction or the X direction.

The image light ML enters the regions RR1 to RR3 respectively at the angles of incidence AN1 to AN3. In each of the regions RR1 to RR3, the inclined angles θ1 to θ3 of the grating DG are set so as to efficiently diffract the image light ML at the angles of incidence AN1 to AN3 input to the regions RR1 to RR3, that is, so as to optimize the diffraction efficiency of the diffracted light of a predetermined order (for example, the positive first order diffracted light). Here, with respect to grating vectors K of the gratings DG in the respective regions RR1 to RR3, components (to be specific, x-components) in the propagation direction of the light guide plate 51a coincide with each other. Thus, the components of the grating vectors K along the surface of the light guide plate 51a in the regions RR1 to RR3 are equal to each other. Thus, the components of the grating period (pitch) P along the surface of the light guide plate 51a in the regions RR1 to RR3 are equal to each other. The grating height of the pattern formed on the incident diffractive layer 51b is constant or substantially constant. Note that the slanted type grating structure may include a binary type grating structure in which the inclined angle is 0° in some regions.

The boundary between the regions RR1 to RR3 is preferably adjusted so that the diffracted light of a predetermined order whose diffraction efficiency is optimized in the regions RR1 to RR3 does not decrease.

As described above, the emission pupil Lx of the projecting optical system 20 is arranged at a position shifted from the grating surface SS of the incident diffractive layer 51b (see FIG. 5). In the present embodiment, since the position of the emission pupil Lx of the projecting optical system 20 is disposed before the light guide plate 51a, the input position of the image light ML to the light guide plate 51a differs depending on the angles of incidence AN1 to AN3. In other words, the projecting optical system 20 has the emission pupil Lx so that the input position to the light guide plate 51a changes depending on the angles of incidence AN1 to AN3. The incident diffractive layer 51b is divided into the plurality of regions AN1 to AN3 in accordance with the input position corresponding to the angles of incidence RR1 to RR3, and serves as the slanted type diffraction grating in which different grating conditions corresponding to the angles of incidence AN1 to AN3 are set for the respective regions RR1 to RR3.

When the angles of incidence AN1 to AN3 of the image light ML are in a relationship AN3>AN2>AN1, the inclined angles θ1 to θ3 of the grating DG are in a relationship θ3>θ2>θ1. That is, as the angle of incidence of the image light ML increases, the optimum inclined angle of the corresponding grating DG, that is, the inclined angle at which the diffraction efficiency is high also increases.

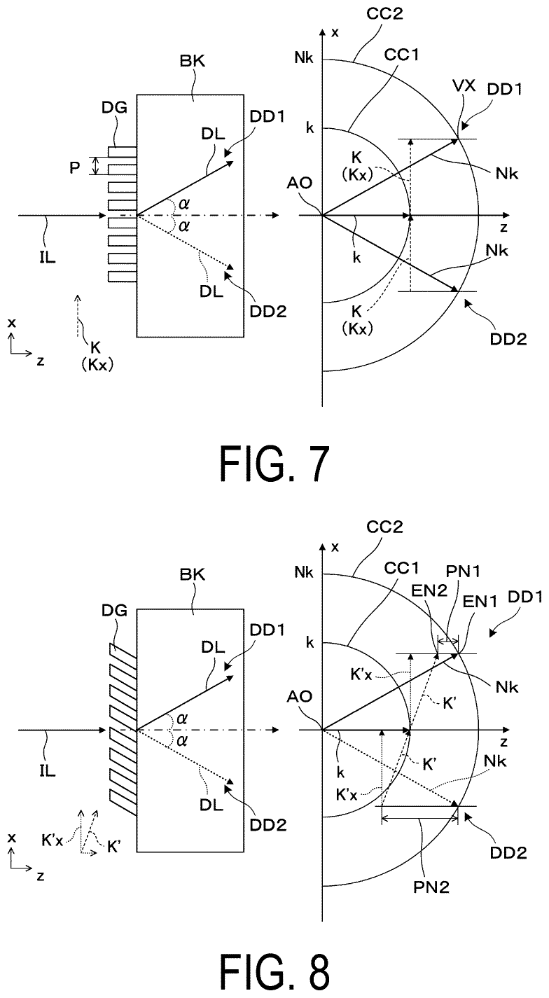

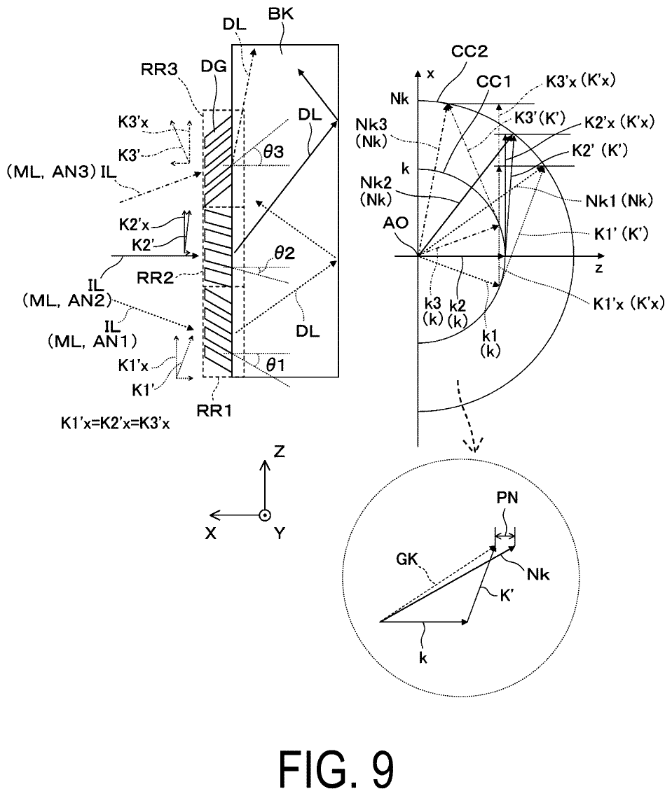

Hereinafter, the principle of optimization of the diffraction efficiency of the incident diffractive layer 51b will be described with reference to FIGS. 7 to 9. FIG. 7 is a conceptual diagram used to explain a relationship between a wave number vector and a grating vector. FIG. 8 is a conceptual diagram used to explain a vector of a slanted type diffraction grating. FIG. 9 is a conceptual diagram used to explain a vector of the diffraction grating of the incident diffractive layer 51b of the present embodiment. In FIG. 9, for convenience of description, the grating DG in any of the regions RR1 to RR3 is slanted, but there may be a region without the slanting (see FIG. 6).

As illustrated in FIG. 7, a diffraction angle x and the like of the grating DG formed on a substrate BK to be considered will be described using an incident light wave number vector k and the grating vector K. Each vector is represented by a wave number k (k=2 π/λ) of light having a wavelength A and the grating vector K (K=2 π/P) of the grating DG with the grating period P. Here, the wavelength λ is a wavelength of incident light IL in the air. The refractive index of the substrate BK is N. A diffracted light wave number vector Nk of diffracted light DL corresponds to a line segment connecting an intersection point VX of an x-component of the grating vector K and a circumference CC2 with a wave number Nk in the substrate BK being the radius and an incident reference point AO of the incident light IL, while drawing the grating vector K from the incident light wave number vector k of the incident light IL in the air on a circumference CC1 with a wave number k being the radius. The diffracted light wave number vector Nk is oriented with the incident reference point AO being the starting point. Although the above description has been given on a positive first order diffraction DD1, the same applies to a negative first order diffraction DD2 and the diffractions of other orders.

A case where the grating DG is inclined with respect to the light guide plate 51a as illustrated in FIG. 8 is considered. In this case, a grating vector K′ is slanted. The diffracted light DL in the slanted type grating DG will be considered. The diffraction angle α is determined by an x-component K′x of the grating vector K′. Therefore, when the x-component K′x of the grating vector K′ illustrated in FIG. 8 is the same as an x-component Kx of the grating vector K illustrated in FIG. 7, the diffraction angle x illustrated in FIG. 8 matches the diffraction angle x illustrated in FIG. 7. Since the grating vector K′ is slanted, an end point EN1 of the diffracted light wave number vector Nk of the positive first order diffraction DD1 and an end point EN2 of the grating vector K′ approach each other. This phenomenon indicates a decrease in a phase mismatch amount PN1 and an increase in the diffraction efficiency. On the other hand, for the negative first order diffraction DD2, a phase mismatch amount PN2 is increased, and therefore the diffraction efficiency is reduced. That is, when the slanted type grating DG is used, the diffraction efficiency can be increased only for a predetermined order. In addition, the phase mismatch amounts PN1 and PN2 change depending on the angle of incidence of the incident light IL. Therefore, it is possible to optimize the diffraction efficiency with respect to the angle of incidence of the image light ML by changing the inclined angle of the grating DG according to the angle of incidence. Since only the x-component K′x of the grating vector K′ is the component affecting the diffraction angle α, even when the inclined angles θ1 to θ3 are changed depending on the regions RR1 to RR3 of the incident diffractive layer 51b illustrated in FIG. 4, the grating vectors of the incident diffractive layer 51b, the pupil expanding grating layer 51e, and the emission diffractive layer 51c are closed as a whole and the compensation relationship can be maintained as long as the x-components K′x of the grating vectors K′ match.

As illustrated in FIG. 9, in the grating DG of the present embodiment, the regions RR1 to RR3 are different from each other in the inclined angles θ1 to θ3. In the present embodiment, based on the above-described principle, the inclined angles θ1 to θ3 of the grating DG are optimized such that x-components K1′x to K3′x of grating vectors K1′ to K3′ of the regions RR1 to RR3 match and the diffraction efficiency is improved with respect to the angles of incidence AN1 to AN3. As a result, the diffraction efficiency of each of the regions RR1 to RR3 is increased, and the light utilization efficiency is improved. In addition, in the grating DG of the present embodiment, the luminance of the image corresponding to the regions RR1 to RR3 is made uniform as compared with a binary type diffraction grating having a uniformly distributed uneven structure (see FIG. 7), and thus luminance non-uniformity is also improved.

In the incident diffractive layer 51b illustrated in FIG. 9, the absolute value of a difference PN between a composite vector GK, which is the sum of the incident light wave number vector k (k1 to k3) of the incident light IL to the incident diffractive layer 51b and the grating vector K′ (K1′ to K3′) of the incident diffractive layer 51b, and the diffracted light wave number vector Nk (Nk1 to Nk3) of the diffracted light DL of the incident diffractive layer 51b is equal to or less than a predetermined value in consideration of optimization of diffraction efficiency. The difference PN corresponds to the phase mismatch amount illustrated in FIG. 8.

Hereinafter, light guiding for the image light ML and formation of a virtual image using the light guide member 50 will be described with reference to FIG. 4 and the like. The image light ML from the image light generation device 10 enters the incident diffractive layer 51b via the light guide plate 51a, is diffracted in an angular direction corresponding to the grating period P of the pattern formed on the incident diffractive layer 51b, is propagated while being totally reflected in the light guide plate 51a, and travels in the +X direction as a whole. At this time, the incident diffractive layer 51b diffracts the diffracted light of a predetermined order in each of the regions RR1 to RR3. The image light ML propagating in the +X direction in the light guide plate 51a is diffracted by the pupil expanding grating layer 51e. Thus, the optical path as a whole is bent in the −Y direction. Then, the image light ML is shifted to a position in the +X direction reflecting the number of reflections until the image light ML is diffracted by the pupil expanding grating layer 51e. That is, the pupil expanding grating layer 51e has a function of expanding the lateral pupil size corresponding to the beam width in the lateral direction or the X direction in which the image light ML enters the eye EY. The image light ML propagating in the light guide plate 51a as a whole in the −Y direction via the pupil expanding grating layer 51e is diffracted and is emitted toward the eye EY by the emission diffractive layer 51c. The image light ML emitted from the emission diffractive layer 51c has an enlarged pupil size in the X direction and the Y direction while reproducing the angular state before being emitted from the image light generation device 10 and entering the light guide member 50 in the X direction and the Y direction. That is, the light guide member 50 enlarges the pupil size in the vertical and horizontal directions while maintaining the image information. Accordingly, the wearer US can observe the virtual image by the image light ML even when the position of the eye EY is shifted.

The virtual image display device 100A, 100B of the first embodiment described above includes the display panel 11a configured to emit the image light ML, the projecting optical system 20 configured to collimate the image light ML from the display panel 11a, and the light guide member 50 that includes the light guide plate 51a configured to guide the image light ML, the input diffractive optical element DI configured to cause the image light ML to enter the light guide plate 51a, and the output diffractive optical element DO configured to cause the image light ML to be emitted from the light guide plate 51a, wherein the input diffractive optical element DI is divided into the plurality of regions RR1 to RR3, and the plurality of regions RR1 to RR3 are different from each other in the grating inclined angles θ1 to θ3 in accordance with the angles of incidence AN1 to AN3 of the image light ML.

In the virtual image display device 100A, 100B, since the plurality of regions RR1 to RR3 of the input diffractive optical element DI are different from each other in the grating inclined angles θ1 to θ3 in accordance with the angles of incidence AN1 to AN3 of the image light ML, in the regions RR1 to RR3, the diffraction efficiency of a predetermined order is optimized, and the light use efficiencies can be improved. In addition, it is possible to improve the uniformity of luminance in the image corresponding to the regions RR1 to RR3.

### Second Embodiment

A virtual image display device according to a second embodiment of the present disclosure is described below. Note that the virtual image display device of the second embodiment is a partial modification of the virtual image display device of the first embodiment, and description of common parts is omitted.

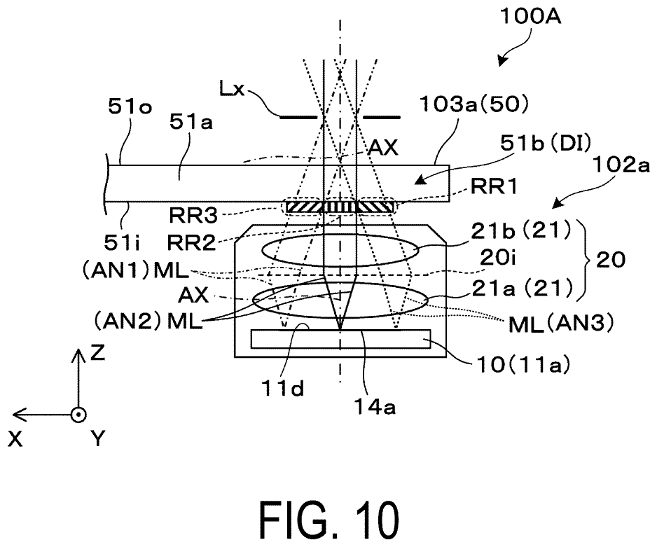

As illustrated in FIG. 10, in a virtual image display device 100A of the present embodiment, the emission pupil Lx of the projecting optical system 20 is arranged on the opposite side of the projecting optical system 20 across the light guide member 50, that is, on the outer side of the incident diffractive layer 51b. In other words, the position of the emission pupil Lx may be behind the light guide plate 51a, and the input position may be changed for each of the angles of incidence AN1 to AN3. In the present embodiment, while the angles of incidence AN1 to AN3 are reduced, the virtual image display device 100A can be downsized.

In the present embodiment, since the position of the emission pupil Lx is behind the light guide plate 51a, the arrangement of the gratings of the regions RR1 to RR3 of the incident diffractive layer 51b is reversed with respect to the center of the grating from the grating illustrated in FIG. 5 and the like. Further, in the present embodiment, the image light ML at the angle of incidence AN3 enters the region RR1, the image light ML at the angle of incidence AN2 enters the region RR2, and the image light ML at the angle of incidence AN1 enters the region RR3. In this case, for each of the regions RR1 to RR3 the size and the inclined angle of the grating are adjusted in accordance with the angles of incidence AN3 to AN1 of the image light ML. In the example in FIG. 10, when the emission pupil Lx is arranged on the outer side of the incident diffractive layer 51b, the inclined angles of the gratings of the outer side regions RR1 and RR3 are inclined outward with respect to the center of the incident diffractive layer 51b, in the incident diffractive layer 51b viewed from the projecting optical system 20. The inclined angle of the grating decreases from the incident diffractive layer 51b side toward the emission diffractive layer 51c side in the lateral direction or the X direction.

### Third Embodiment

A virtual image display device according to a third embodiment of the present disclosure is described below. Note that the virtual image display device of the third embodiment is a partial modification of the virtual image display device of the first embodiment, and description of common parts is omitted.

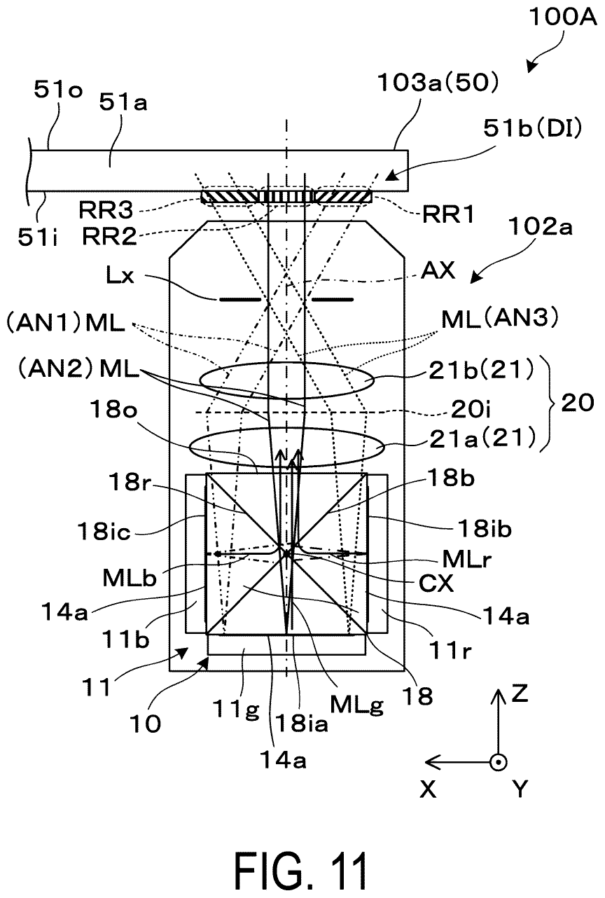

As illustrated in FIG. 11, in a virtual image display device 100A of the present embodiment, the image light generation device 10 of the first display driving unit 102a includes three display panels 11r, 11b, and 11g and a cross dichroic prism 18. The projecting optical system 20 is a collimator including a plurality of lenses 21a and 21b as the lens elements 21.

The display panel 11r for red is a first display panel and emits red image light MLr which is first image light. The display panel 11r is, for example, a micro OLED display, forms a still image or a movie on a two-dimensional display surface parallel to the YZ plane, and emits the red image light MLr.

The display panel 11b for blue is a second display panel and emits blue image light MLb which is second image light. Like the display panel 11r for red, the display panel 11b is, for example, a micro OLED display, forms a still image or a movie on a two-dimensional display surface parallel to the YZ plane, and emits the blue image light MLb. The light emitting element 14a incorporated in the display panel 11b for blue and the light emitting element 14a of the display panel 11r for red are different from each other in light emitting wavelength. Thus, the blue image light MLb which is the second image light and the red image light MLr which is the first image light are different from each other in wavelength range.

The display panel 11g for green is a third display panel and emits green image light MLg which is third image light. Like the display panel 11r for red, the display panel 11g is, for example, a micro OLED display, forms a still image or a movie on a two-dimensional display surface parallel to the XY plane, and emits the green image light MLg. The light emitting element 14a incorporated in the display panel 11g for green and the light emitting element 14a of the display panels 11r and 11b for red and blue are different from each other in light emitting wavelength. Thus, the red image light MLr which is the first image light and the blue image light MLb which is the second image light are different from each other in wavelength range. Thus, the green image light MLg which is the third image light, the red image light MLr which is the first image light, and the blue image light MLb which is the second image light are different from each other in wavelength range.

Each of the light emitting elements 14a incorporated in the display panels 11r, 11b, and 11g is a micro OLED display provided with a first order resonance type cavity. Therefore, according to the orientation characteristics of the display panels 11r, 11b, and 11g, the light intensity is high in the front side direction parallel to the optical axis AX, and the light intensity sharply drops in a direction slightly inclined with respect to the front side direction. Assuming that an angle at which the light intensity is halved is a radiation angle, the radiation angle from the pixel for the red image light MLr, the radiation angle from the pixel for the blue image light MLb, and the radiation angle from the pixel for the green image light MLg from the pixel are within about 20°. Dichroic mirrors 18r and 18b of the cross dichroic prism 18, which will be described later, are designed based on the radiation angles of the image light MLr, MLb, and MLg.

The display panel 11r for red is fixed so as to be attached to a first light incident surface 18ib of the cross dichroic prism 18. The first display panel 11r for red causes the red image light MLr, which is the first image light, to enter the cross dichroic prism 18 from the first light incident surface 18ib. The display panel 11b for blue is fixed so as to be attached to a second light incident surface 18ic of the cross dichroic prism 18. The second display panel 11b for blue causes the blue image light MLb, which is the second image light, to enter the cross dichroic prism 18 from the second light incident surface 18ic. The display panel 11g for green is fixed so as to be attached to a third light incident surface 18ia of the cross dichroic prism 18. The third display panel 11g for green causes the green image light MLg, which is the third image light, to enter the cross dichroic prism 18 from the third light incident surface 18ia.

The cross dichroic prism 18 has a structure in which four right-angled triangular prisms formed of a glass material or the like are joined with the right-angled edges coinciding with each other, and two dichroic mirrors 18r and 18b orthogonal to each other are embedded in the joint portions. One dichroic mirror 18r is disposed at an angle of 45° with respect to the first incident surface 18ib. The dichroic mirror 18r forms a surface connecting diagonal corners of a square contour as viewed in the direction of an intersecting axis CX of the cross dichroic prism 18. The other dichroic mirror 18b is disposed at an angle of 45° with respect to the second incident surface 18ic. The dichroic mirror 18b forms a surface connecting diagonal corners of a square contour as viewed in the direction of an intersecting axis CX of the cross dichroic prism 18.

The red image light MLr having entered the first incident surface 18ib of the cross dichroic prism 18 from the first display panel 11r for red is reflected by the dichroic mirror 18r to be bent toward the emission side, that is, the projecting optical system 20, and is emitted from a light emission surface 180 to the outside in the +Z direction. The blue image light MLb having entered the second incident surface 18ic of the cross dichroic prism 18 from the second display panel 11b for blue is reflected by the dichroic mirror 18b to be bent toward the emission side, that is, the projecting optical system 20, and is emitted from the light emission surface 180 to the outside in the +Z direction. The green image light MLg having entered the third incident surface 18ia of the cross dichroic prism 18 from the third display panel 11g for green passes through the cross dichroic prism 18 toward the projecting optical system 20 without being reflected by the dichroic mirrors 18r and 18b, and is emitted from the light emission surface 180 to the outside in the +Z direction. That is, the green image light MLg transmits through the cross dichroic prism 18. As a result, the images can be combined with the red image light MLr, the green image light MLg, and the blue image light MLb superimposed in the cross dichroic prism 18, to be emitted as the image light ML and caused to enter the projecting optical system 20.

In the cross dichroic prism 18, the intersecting axis CX extends along the line of intersection of the two dichroic mirrors 18r and 18b and is parallel to the Y direction. The optical axis AX passing through the light emission surface 180 of the cross dichroic prism 18 extends in a lateral direction perpendicular to the light guide plate 51a, that is, in the Z direction.

The projecting optical system 20 is an optical system that is substantially telecentric with respect to the side of the display panels 11r, 11b, and 11g, which is the object side. That is, the principal light beam of the image light MLg, the image light MLr, and the image light MLb emitted from the respective portions of the light emitting elements 14a which are the display surfaces of the respective display panels 11b, 11r, and 11g pass through the light incident surfaces 18ib, 18ic, and 18ia of the cross dichroic prism 18 in a state of being substantially parallel to the optical axis AX, and thus enters the cross dichroic prism 18 and is emitted from the cross dichroic prism 18 while being substantially parallel to the optical axis AX. Accordingly, the red image light MLr, the green image light MLg, and the blue image light MLb within a predetermined angle range or less enter the dichroic mirrors 18r and 18b, whereby the light loss due to the dichroic mirrors 18r and 18b can be suppressed.

The arrangement of the display panels 11b, 11r, and 11g can be changed as appropriate.

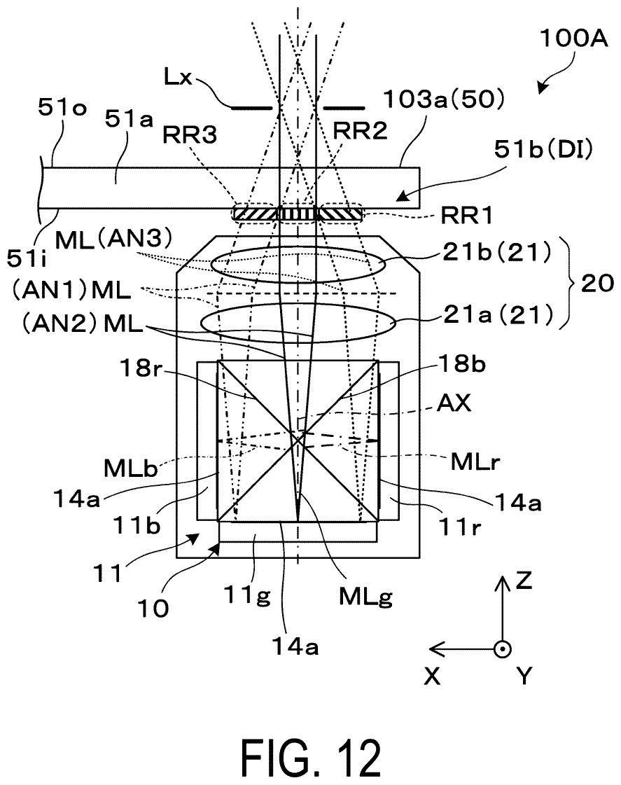

As illustrated in FIG. 12, the virtual image display device 100A of the present embodiment may have the same configuration as that in the second embodiment. To be more specific, the emission pupil Lx is arranged on the outer side of the incident diffractive layer 51b located opposite to the projecting optical system 20.

### Fourth Embodiment

A virtual image display device according to a fourth embodiment of the present disclosure is described below. Note that the virtual image display device of the fourth embodiment is a partial modification of the virtual image display device of the first embodiment, and description of common parts will be omitted.

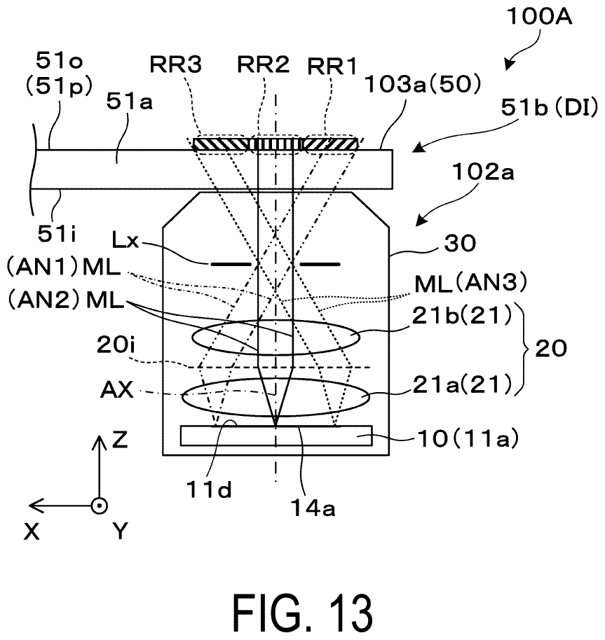

As illustrated in FIG. 13, in the virtual image display device 100A of the present embodiment, the incident diffractive layer 51b is disposed on the external side, that is, the +Z side of the light guide plate 51a. Specifically, the incident diffractive layer 51b is disposed on the surface opposite to the projecting optical system 20 in the light guide plate 51a, that is, on the second total reflection surface 510 which is a back surface 51p of the light guide plate 51a. In this case, although not elaborated in the figures, the emission diffractive layer 51c and the pupil expanding grating layer 51e are also arranged on the external side of the light guide plate 51a. The incident diffractive layer 51b, the emission diffractive layer 51c, and the pupil expanding grating layer 51e are designed to function as reflective diffraction gratings that partially transmit external light. The farther the incident diffractive layer 51b is from the emission pupil Lx, the easier it is to implement the division into the regions RR1 to RR3. In this case, the number of divided regions can be increased.

### Fifth Embodiment

A virtual image display device according to a fifth embodiment of the present disclosure is described below. The virtual image display device of the fifth embodiment is a partial modification of the virtual image display device of the first embodiment and description of common parts will be omitted.

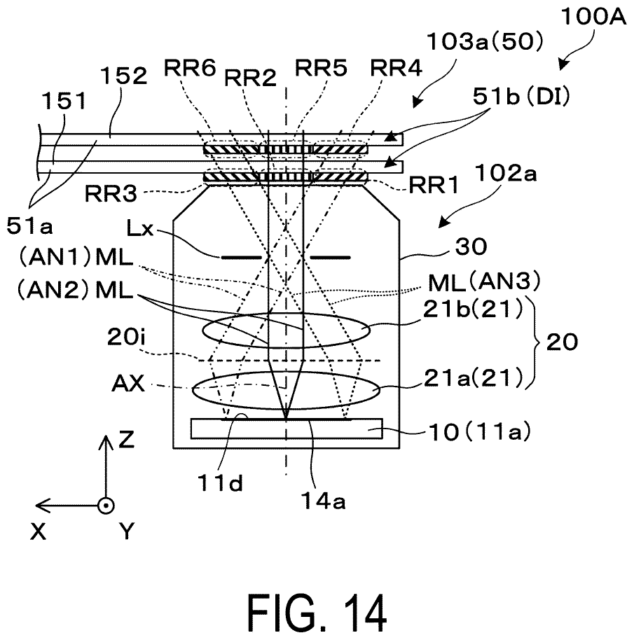

As illustrated in FIG. 14, in the virtual image display device 100A of the present embodiment, the first light guide optical system 103a has a plurality of the light guide plates 51a stacked in parallel. Specifically, the first light guide optical system 103a includes a first light guide member 151 and a second light guide member 152 that diffracts the image light ML in a wavelength range different from that of the first light guide member 151. Each of the first and the second light guide members 151 and 152 includes the light guide plate 51a, the incident diffractive layer 51b, the emission diffractive layer 51c, and the pupil expanding grating layer 51e.

The first light guide member 151 and the second light guide member 152 are optimized according to the wavelength range of the image light ML. The first and the second light guide members 151 and 152 may correspond to three colors of RBG, for example. The light guide plates 51a of the first and the second light guide members 151 and 152 are in charge of different colors, whereby the diffraction efficiency and the luminance uniformity can be further improved. Specifically, the first light guide member 151 has, for example, the grating period or the like of the incident diffractive layer 51b set to make the blue light and the green light propagate. The second light guide member 152 has, for example, the grating period or the like of the incident diffractive layer 51b set to make the red light propagate. The first light guide member 151 includes the incident diffractive layer 51b divided into the regions RR1 to RR3. The second light guide member 152 includes the incident diffractive layer 51b divided into regions RR4 to RR6. The region RR1 to RR6 of the first light guide member 151 and the second light guide member 152 are different from each other in inclined angle and the like. The regions RR1 to RR6 may be different from each other in size and position. In the incident diffractive layer 51b, the boundary between the regions RR1 and RR6 can be shifted, or another region can be added.

Three light guide members may be provided corresponding to three respective colors.

### Others

The structures described above are examples and various modifications can be made without departing from the scope capable of achieving the same functions.

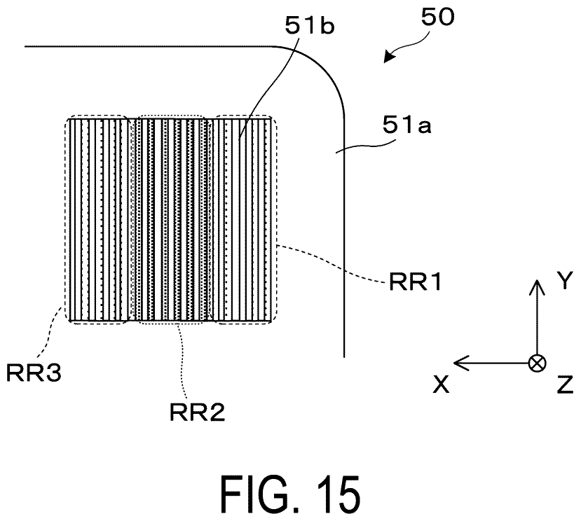

As illustrated in FIG. 15, the shape of the incident diffractive layer 51b is not limited to a circular shape and can be appropriately changed to another shape such as a rectangular shape, for example.

The inclined angles θ1 to θ3 of the gratings DG in the respective regions RR1 to RR3 of the incident diffractive layer 51b can be appropriately adjusted. In addition, the order of the diffracted light DL for increasing the diffraction efficiency can also be appropriately adjusted.

The grating structure of the incident diffractive layer 51b is not limited to a slanted type grating, and may include a binary type grating that is not slanted as described above or a blade type grating.

The incident diffractive layer 51b, the emission diffractive layer 51c, and the pupil expanding grating layer 51e may be formed from volumetric holograms. The incident diffractive layer 51b, the emission diffractive layer 51c, and the pupil expanding grating layer 51e are not limited to ones formed of a single layer, and may be formed by stacking a plurality of functional layers adapted to the wavelengths and the like of the image light ML.

The light guide member 50 is not limited to one including the incident diffractive layer 51b, the emission diffractive layer 51c, and the pupil expanding grating layer 51e, and for example, the pupil expanding grating layer 51e can be omitted. In this case, the incident diffractive layer 51b causes the collimated image light ML to be guided into the light guide plate 51a and propagate in the lateral direction, and the emission diffractive layer 51c causes the image light ML to be emitted toward the pupil position PP on the inner side of the image light ML propagating in the lateral direction in the light guide plate 51a.

Although it has been described above that the virtual image display device 100A, 100B can be used as an HMD, the present disclosure is not limited thereto and can be applied to various optical devices, for example, a head-up display (HUD).

A virtual image display device according to a specific aspect includes a display panel configured to emit image light, a projection optical system configured to collimate the image light from the display panel, and a light guide member that includes a light guide plate configured to guide the image light, an input diffractive optical element configured to cause the image light to enter the light guide plate, and an output diffractive optical element configured to cause the image light to be emitted from the light guide plate, wherein the input diffractive optical element is divided into a plurality of regions, and the plurality of regions are different from each other in an inclined angle of a grating in accordance with an angle of incidence of the image light.

In the virtual image display device, since the plurality of regions of the input diffractive optical element are different from each other in the grating inclined angle in accordance with the angles of incidence of the image light, in the regions, the diffraction efficiency of a predetermined order is optimized, and the light use efficiencies can be improved. In addition, it is possible to improve the uniformity of luminance in the image corresponding to the regions.

In the virtual image display device according to a specific aspect, a component of a grating vector along a surface of the light guide plate in each of the regions is same among the plurality of regions.

In the virtual image display device according to a specific aspect, in a lateral cross section of the input diffractive optical element passing through an orthogonal axis perpendicular to a surface of the light guide plate, a rotation in a first direction with respect to the orthogonal axis is defined as a positive angle, and a rotation in a second direction opposite to the first direction with respect to the orthogonal axis is defined as a negative angle, and in the plurality of regions, the inclined angle increases as the angle of incidence increases.

In the virtual image display device according to a specific aspect, an emission pupil of the projection optical system is arranged at a position shifted from a grating surface of the input diffractive optical element. In this case, the input position of the image light to the input diffractive optical element changes in accordance with the angle of incidence of the image light.

In the virtual image display device according to a specific aspect, the emission pupil is disposed between the projection optical system and the input diffractive optical element, and in the input diffractive optical element viewed from the projection optical system, the inclined angle of the grating of one of the regions on outer side is inclined inward with respect to center of the input diffractive optical element. In this case, it is possible to cope with a large angle of incidence.

In the virtual image display device according to a specific aspect, the emission pupil is disposed on outer side of the input diffractive optical element opposite to the projection optical system, and in the input diffractive optical element viewed from the projection optical system, the inclined angle of the grating of one of the regions on outer side is inclined outward with respect to center of the input diffractive optical element. In this case, while the angle of incidence becomes small, the device can be downsized.

The virtual image display device according to a specific aspect includes a first display panel that is the display panel configured to emit first image light of the image light, a second display panel configured to emit second image light of a wavelength range different from that of the first image light, a third display panel configured to emit third image light of a wavelength range different from those of the first image light and the second image light, and a cross dichroic prism configured to combine the first image light, the second image light, and the third image light. With the first image light, the second image light, and the third image light thus combined, it is possible to display a virtual image with high luminance.

The virtual image display device according to a specific aspect includes a first light guide member that is the light guide member, and a second light guide member configured to diffract the image light in a wavelength range different from that of the first light guide member. In this case, the diffraction efficiency can be optimized in accordance with the wavelength range of the image light.

In the virtual image display device according to a specific aspect, the display panel is an organic light emitting diode.

A optical unit according to a specific aspect includes a display panel configured to emit image light, a projection optical system configured to collimate the image light from the display panel, and a light guide member that includes a light guide plate configured to guide the image light, an input diffractive optical element configured to cause the image light to enter the light guide plate, and an output diffractive optical element configured to cause the image light to be emitted from the light guide plate, wherein the input diffractive optical element is divided into a plurality of regions, and the plurality of regions are different from each other in an inclined angle of a grating in accordance with an angle of incidence of the image light.

What is claimed is:

1. A virtual image display device comprising:
a display panel configured to emit image light;
a projection optical system configured to collimate the image light from the display panel; and
a light guide member that includes a light guide plate configured to guide the image light, an input diffractive optical element configured to cause the image light to enter the light guide plate, and an output diffractive optical element configured to cause the image light to be emitted from the light guide plate, wherein
the input diffractive optical element is divided into a plurality of regions, and the plurality of regions are different from each other in an inclined angle of a grating in accordance with an angle of incidence of the image light.

2. The virtual image display device according to claim 1, wherein a component of a grating vector along a surface of the light guide plate in each of the regions is same among the plurality of regions.

3. The virtual image display device according to claim 1, wherein
in a lateral cross section of the input diffractive optical element passing through an orthogonal axis perpendicular to a surface of the light guide plate, a rotation in a first direction with respect to the orthogonal axis is defined as a positive angle, and a rotation in a second direction opposite to the first direction with respect to the orthogonal axis is defined as a negative angle, and
in the plurality of regions, the inclined angle increases as the angle of incidence increases.

4. The virtual image display device according to claim 1, wherein an emission pupil of the projection optical system is arranged at a position shifted from a grating surface of the input diffractive optical element.

5. The virtual image display device according to claim 4, wherein
the emission pupil is disposed between the projection optical system and the input diffractive optical element, and
in the input diffractive optical element viewed from the projection optical system, the inclined angle of the grating of one of the regions on outer side is inclined inward with respect to a center of the input diffractive optical element.

6. The virtual image display device according to claim 4, wherein
the emission pupil is disposed on outer side of the input diffractive optical element opposite to the projection optical system, and
in the input diffractive optical element viewed from the projection optical system, the inclined angle of the grating of one of the regions on outer side is inclined outward with respect to a center of the input diffractive optical element.

7. The virtual image display device according to claim 1, comprising:
a first display panel that is the display panel configured to emit first image light of the image light;
a second display panel configured to emit second image light of a wavelength range different from that of the first image light;
a third display panel configured to emit third image light of a wavelength range different from those of the first image light and the second image light; and
a cross dichroic prism configured to combine the first image light, the second image light, and the third image light.

8. The virtual image display device according to claim 1, comprising:
a first light guide member that is the light guide member; and
a second light guide member configured to diffract the image light in a wavelength range different from that of the first light guide member.

9. The virtual image display device according to claim 1, wherein the display panel is an organic light emitting diode.

10. An optical unit comprising:
a display panel configured to emit image light;
a projection optical system configured to collimate the image light from the display panel; and
a light guide member that includes a light guide plate configured to guide the image light, an input diffractive optical element configured to cause the image light to enter the light guide plate, and an output diffractive optical element configured to cause the image light to be emitted from the light guide plate, wherein
the input diffractive optical element is divided into a plurality of regions, and the plurality of regions are different from each other in an inclined angle of a grating in accordance with an angle of incidence of the image light.
